(19) United States
(12) Patent Application Publication
(10) Pub. No.: US 2012/0330708 A1
(43) Pub. Date: Dec. 27, 2012

(54) Perfect match for job description to job seeker resumes and job seeker resume to jobs.

(76) Inventor: Mahmood A. Khan, San Jose, CA (US)

(21) Appl. No.: 13/374,119

(22) Filed: Dec. 12, 2011

Related U.S. Application Data
(60) Provisional application No. 61/422,659, filed on Dec. 14, 2010.

(51) Int. Cl. G06Q 10/06

(52) U.S. Cl. 705/7.14; 705/321

(57) ABSTRACT

The system and method disclosed herein permits hiring managers and jobseekers to receive a ranked list of matching resumes for their posted jobs and resumes respectively. The system administrators and the PerfectMatch Engine validates the jobs and resumes prior to executing the matching process. All users, hiring managers, job seekers and administrators are provided secure access with capability to manage only their data. The validated jobs and resumes are automatically matched by the matching engine creating a ranked list of resumes for each job and jobs for each resume. The job and resume owners are notified of the matches for further action.

### CROSS REFERENCE RELATED APPLICATIONS

This application claims benefit of prior filing as follows:

Application No. 61/422,659

Filing Date: Dec. 14, 2010

### GOVERNMENT FUNDING

N/A

### BACKGROUND

With the increased use of the Internet for both advertising open job positions, posting of resume for hiring managers or recruiters to review and applying for a job has become a common place. There are many job boards and social media websites including LinkedIn, Google Jobs, Facebook, Company website, etc. Many have the same job posting often misleading jobseekers there are more jobs than in reality. There are also many jobseekers chasing the same jobs and applying for unsuitable jobs lacking qualifications. Many job postings are also misleading and are there just to collect resumes with jobseekers contact information for later use and in some cases use other than offering jobs. A recent query on Google for “Project Manager Jobs” resulted in 264,282 jobs. Another search shortly after at Indeed.com resulted in 451,243 for the same query. A Project Manager looking to apply for a job has to sieve through these by narrowing their search by key words such as the City, State, Zip code, to have any hope of finding a remotely suitable position before reviewing the details of the posted job. This often makes a decision to apply for any job very time consuming, risky and sending resume in the www abyss. With so many jobs to select from a likely scenario is to apply for a job with a slim hope of getting any response let alone an interview request from the hiring manager. When applying for a job, the job board or a company website often require a login registration and posting of resume. This is an extremely time consuming task and causes long delays before a real hiring manager interviews a candidate.\

Posting jobs at job boards and social media and company website has another set of issues. They include posting of jobs at any number of websites, listing services providers and search engines. A company must accommodate for getting and processing hundreds of applications for each job. Companies are often seek help from professional recruiters at great cost to them. The recruiters receive the resumes and have to sieve through the stack to find suitable candidates. The recruiter also use job boards, social media sites such as LinkedIn and own expensive system to search for suitable candidates at great cost to them which is in turn passed to their clients. Their searches are based on limited number of key words and manually reviewing the resumes for suitable candidates. Once a candidate resume is found, the recruiter or hiring manager has to review the details and determine if the resume is worth reviewing further. To select a resume it is very time consuming and costly. Some data show that with of all the modern tools, search engines, list services, social media and the job boards, it is still taking many weeks to find a handful of candidates for initial screening. A cycle of several months to hire a suitable candidate for a position is common. For professionals and specialty skilled workers it can take several times longer.

The presented method and system for matching candidates to jobs and jobs to candidates can dramatically shorten the search time for suitable candidates and very quickly identify the suitable jobs to a jobseeker thus reducing cost, and freeing up unnecessary resources for other more productive uses.

### PREVIOUS PATENTS

U.S. Pat. No. 7,188,074B2

### FIELD OF USE

Job search and talent acquisition.

### BRIEF SUMMARY OF THE INVENTION

The present disclosure relates to matching jobseekers to jobs and jobs to job seekers. In particular, it relates to systems and methods for providing job to resume matching and resume to jobs matching services based on job requirements and jobseeker qualifications. The matching services relate to systems and methods for providing matching services for hiring manager and jobseekers.

The invention provides a method for hiring managers to automatically search a database of resumes to match the job requirements and qualifications as defined in a job description and receive a ranked list of matching resumes. This shortens the time to identify qualified candidates from many weeks effort to just a few hours.

The invention also provides a method for jobseekers to automatically search a database of jobs in the service provider database to match the resume qualifications defined in a resume and receive a ranked list of matching jobs. This shortens the time to identify open jobs from weeks in some cases to just a few hours.

The job requirements are defines in the form of dimensions and scored to enable standardizing job requirements and ranking. The software guides the user to create precise job requirements and qualification and highlight importance of each. This prevents confusions and describes attracts the right candidates to apply for the job. Thus discouraging unqualified candidates to apply for the job and cluttering the job search process.

The resume qualifications and experiences are defined in the form of dimensions to standardize resume qualifications and ranking. This helps job seeker better articulate their acumens and qualifications.

A matching engine with job to resume and resume to jobs is outlined to gather and create the right jobseekers for the job and right jobs for the jobseeker. This reduces the time to search for candidates and jobs using commonly used listing provider and manual search techniques with keyword searches and guessing whether the job or candidate are of high quality.

The job requirements are automatically matched with resume qualifications and a ranked list created for the hiring manager. To accomplish this with current techniques is very time consuming and costly undertaking. The matching engine does it just a few hours presenting validated candidates and jobs.

The resume qualifications are automatically matched with jobs and a ranked list of jobs is created for the job seeker. To accomplish this with currently available techniques and manual process is very time consuming and costly.

The matching engine notifies the hiring manager of highly accurate ranked matches found for their job description(s) stored in the system. The current techniques do not.

The matching engine notifies the jobseeker of highly accurate ranked matches found for their resume(s) stored in the system. This current techniques do not.

A sample system with the capabilities is outlined.

### BRIEF DESCRIPTION OF THE DRAWINGS

FIG. 1 depicts a method process flow diagram for matching jobs and resumes resulting in a ranked list of candidates for each job and a ranked list of jobs for each resume. Each ranked list is submitted for notification to the respective hiring manager and jobseeker.

FIG. 2 depicts a component diagram of a system for providing matching service for jobs and resumes matching services.

FIG. 3 depicts a component diagram of computing device according to one embodiment.

FIG. 4 depicts an exemplary user interface for hiring manager access module 204 in FIG. 2 with available capabilities to create and manager job postings and receives notification of available resume and reviews them.

FIG. 5 depicts an exemplary user interface for create job description depicted in FIG. 4.

FIG. 6 depicts an exemplary user interface for selecting and creating a job requirement and qualification dimension sample user interface depicted in FIG. 5. Furthermore it also depicts a user option for entering a new dimension value not available in the choices presented.

FIG. 7 depicts an exemplary user interface for job seeker access module 205 in FIG. 2 with available capabilities to create and manage resume posting and receive notification of available jobs and review them.

FIG. 8 depicts an exemplary user interface for create resume depicted in FIG. 7.

FIG. 9 depicts an exemplary user interface for selecting and creating a resume dimension for a resume depicted in FIG. 7. Furthermore it also depicts a user option for entering a new dimension value not available in the choices presented.

FIG. 10 depicts is an exemplary user interface for administrator access module 206 depicted in FIG. 2 with available capabilities to job scoring and validation, resume scoring and validation, review notification.

FIG. 11 depicts a process flow diagram for providing Job Scoring and Validation according to one embodiment.

FIG. 12 depicts a process flow diagram for job to resume matching according to one embodiment.

FIG. 13 depicts process flow diagram for providing Resume Scoring and Validation according to one embodiment.

FIG. 14 depicts a process flow diagram for resume to jobs matching according to one embodiment.

### DETAILED DESCRIPTION OF A PREFERRED EMBODIMENT

The system and method disclosed herein permits hiring managers and jobseekers to receive a ranked list of matching resumes for their posted jobs and resumes respectively. A hiring manager is given a secure access via their unique identity and password. to create their job description(s) by creating job requirement and qualification dimensions and specifying importance of each. A jobseeker is given a secure access via their unique identity and password to create their resume(s) by creating resume qualification dimensions and scoring each dimension. The job requirements and qualification dimensions and resume qualification dimensions are validated for accuracy by the software and one or more administrators. Each administrator is given a secure access via their unique identity and password. Each administrator is associated with a hiring manager(s) and or job seeker(s) to validate their job postings in case of hiring manager and resumes in case of job seeker. The validated job descriptions are automatically matched by the matching engine with validated resumes creating a ranked list of resume for each job. The validated resumes are automatically matched by the matching software with validated jobs creating a ranked list of jobs for each resume. The ranked lists are communicated to the owners of each job and resume for further actions. The hiring manager, job seeker and administrator require user id and password to access the system via a computing device. Each hiring manager, job seekers, and administrator accesses the system via a secured interface and has a user profile that includes their email and contact information and account privileges and capabilities stored in the system.

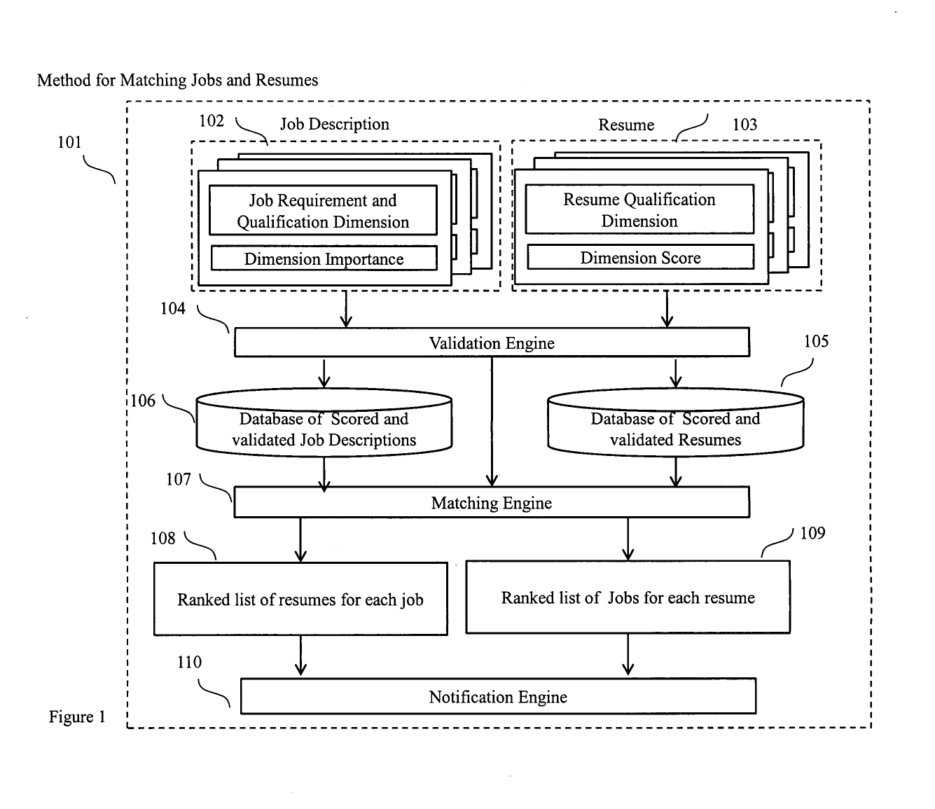

FIG. 1 depicts a process flow diagram of a method for matching jobs and resume 101. Hiring manager creates Job description made up of one or more job requirements and qualification dimension and dimension importance 102, and jobseeker creates resume made up of one or more resume qualification dimension and dimension score 103 according to one embodiment. The job description and resume are submitted to validation engine 104. Score validation includes weighted importance against dimension importance and administrator validation according to one embodiment. The validation engine automatically scores and stores the validated job description in database of scores and validated Job Descriptions 106, according to one embodiment. The validation engine automatically validates and scores and stores the validated resumes in database of scores and validated resumes 105, according to one embodiment. Matching Engine 107 receiving the validated scored job descriptions and or resumes and produces a ranked list of resumes for each job 108 and a ranked list of jobs for each resume 109. A ranked list of resume for a job is submitted for delivery to the hiring manager via notification engine 109 according to one embodiment. A ranked list of jobs for a resume is submitted for delivery to the jobseeker via notification engine 109 according to one embodiment.

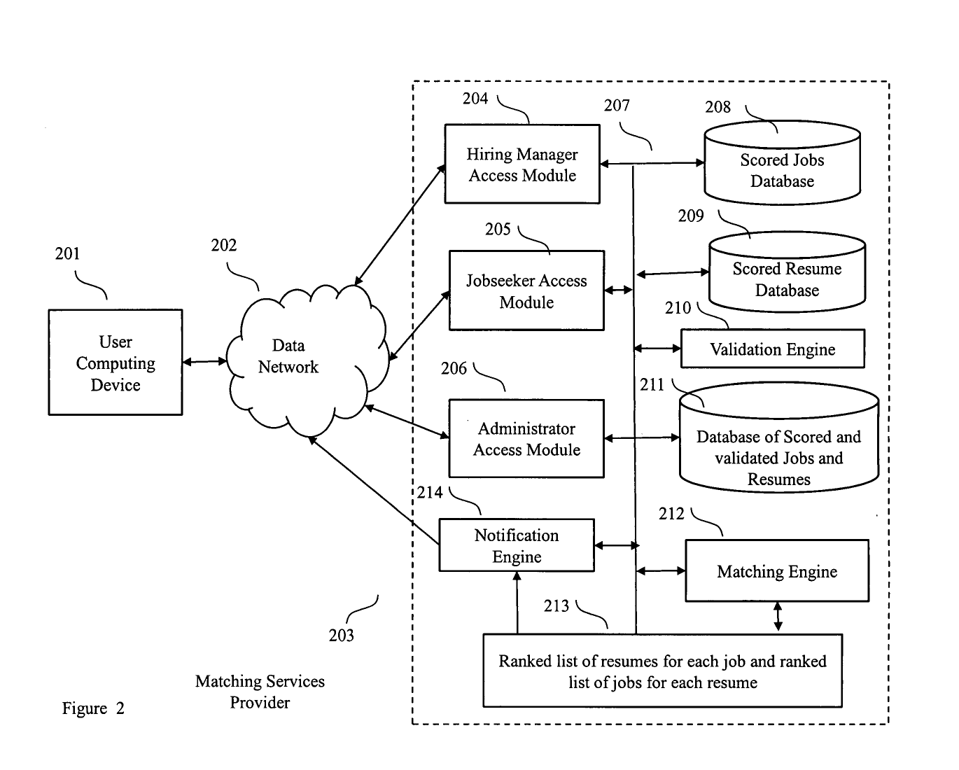

FIG. 2 depicts a component diagram of a system for providing resumes to job and job to resumes matching services according to one embodiment. Resume and job matching services can be provided by a Matching Services Provider 203. In one embodiment, the matching services provider 203 can host an online service for posting job descriptions and posting resumes according to one embodiment. As such the matching services provider 203 can be a business entity that owns and operates a computer infrastructure connected to a data network 202 in order to provide matching services.

A hiring manager can access the services provided by 203 via a data network 202. The data network is the Internet. The hiring manager can utilize a User Computing Device 201 to communicate via the data network 202 with one or more computing modules and services provided by Hiring Manager Access Module that are part of the computer infrastructure managed by the matching services provider 203.

Utilizing the User Computing Device 201 a hiring manager can access the Hiring Manager Access Module 204 to post job descriptions 102 in the scored jobs database 208. Each job posting is associated with the hiring manager profile which includes login id, password, and email address and or phone number for short message services. The profile is use by the notification engine 214.

Utilizing the User Computing Device 201 a jobseeker can access the jobseeker Access Module 205 to post resume 103 in the scored resume database 209. Each resume is associated with the jobseeker profile which includes login id, password, and email address and or phone number for short message services. The profile is use by the notification engine 214.

Utilizing the User Computing Device 201 an administrator can access the administrator access module 206 to validate jobs and resumes in scored jobs and resume databases 208 and 209 respectively. The jobs and resumes are validated through the validation engine 210 according to one embodiment and stored in the database of scored and validated jobs and resume 211. Each hiring manager and jobseeker is associated with an administrator. The association is set up by the matching service provider. The administrator association with hiring manager and/or job seeker enables access to job descriptions and resume or respective hiring manage and job seeker for validation. The administrator profile is use by the notification engine 214 to notify administrator of new jobs and resume posting requiring validation.

The Matching Engine 212 runs automatically and selects each new or updated job in 211, the database of scored and validated jobs and resumes, and creates or updates a ranked list with matching resumes in 211. The new or updated ranked list of resume for each job is submitted for notification to the hiring manager.

The Matching Engine 212 runs automatically and selects each new or updated resume in 211, the database of scored and validated jobs and resumes, and creates or updates the ranked list with matching jobs in 211. The new or updated ranked list of jobs for each resume is submitted for notification to the jobseeker.

The notification Engine 214 receives the resume ranked list and sends an electronic notification in the form of email or SMS to alert the hiring manager of matches found for the posted job. The Hiring Manager receives the electronic message via the data network 202.

The notification Engine 214 receives the jobs ranked list and sends an electronic notification in the form of email or SMS to alert to the jobseeker of matches found for the resume. The jobseeker receives the electronic message via the data network 202.

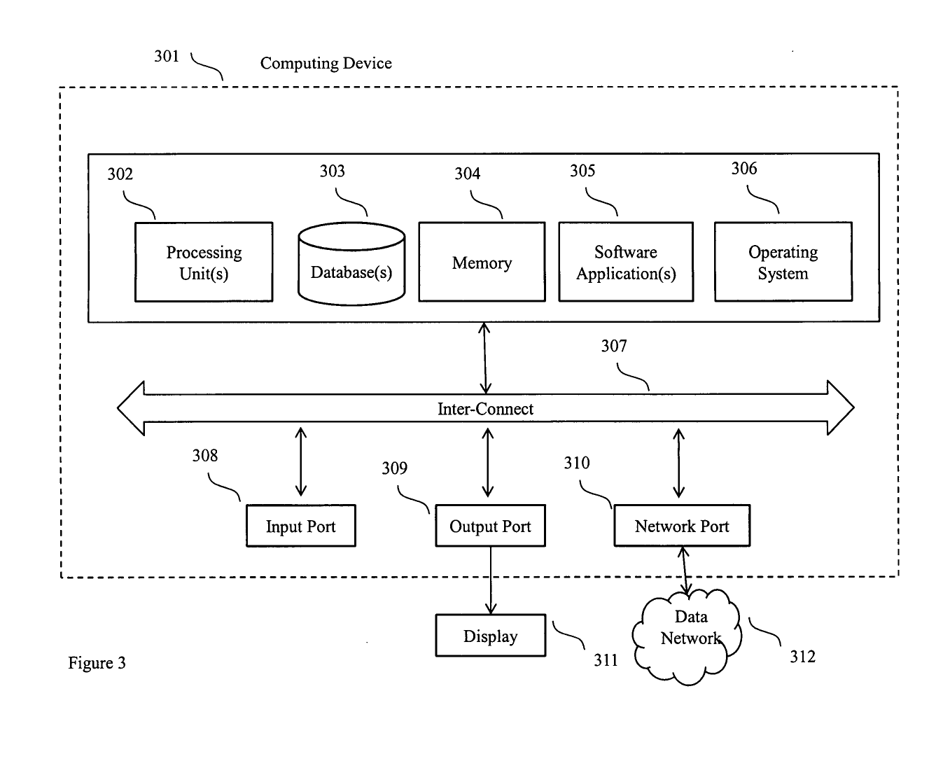

FIG. 3 depicts a component diagram of a computing device according to one embodiment. The computing device 301 can be utilized to implement one or more computing devices, computer processes, or software modules described herein. In one example, the computing device 301 can be utilized to process calculations, execute instructions, receive and transmit digital signals, as required by the hiring manager computing device 201, jobseeker computing device 201, and administrator computing device 201. In another example, the computing device 301 can be utilized to provide the matching services provided by a services provider in 203. These services include database services, processing of calculations, execute instructions, receive and transmit digital signals, processing matching algorithms required by the validation and matching engines, receive notifications of matching resumes for job descriptions and jobs for resume, and provide database services for hiring manager, jobseeker and administrator modules in 204, 205, and 206.

The computing device 301 can be any general or special purpose computer now known or to become known capable of performing the steps and/or performing the functions described herein, either in software, hardware, firmware, or a combination thereof.

The computing device 301 includes an inter-connect 307 (e.g., bus and system core logic), which interconnect processing unit(s) 302, database (s) 303, memory 304, application(s) 305 and operating system 306 together. Furthermore, the interconnect 307 interconnects the interconnect processing unit(s) 302, database(s) 303, memory 304, application(s) 305 and operating system 306 to peripheral devices such input ports 308, output ports 309 and network port 310. Input ports 308 and output ports 309 can communicate with I/O devices such as mice, keyboards, modems, network interfaces, printers, scanners, video cameras and other devices. In addition, the output port 309 can further communicate with the display 311.

Furthermore, the interconnect 307 may include one or more buses connected to one another through various bridges, controllers and/or adapters. In one embodiment, input ports 308 and output ports 309 can include a USB (Universal Serial Bus) adapter for controlling USB peripherals, and/or an IEEE-1394 bus adapter for controlling IEEE-1394 peripherals. The inter-connect 307 can also include a data network connection 312.

The memory 304 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 304 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 304 or obtained through input ports 308 and output ports 309.

In general, routines executed to implement one or more embodiments may be implemented as part of an operating system 306 or a specific application, component, program, object, module or sequence of instructions referred to as software application(s) 305. A software application 305 typically can comprises of one or more instruction sets that can be executed by the processing unit(s) 302 to perform operations necessary to execute elements involving the various aspects of the methods and systems as described herein. For example, the application software 305 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

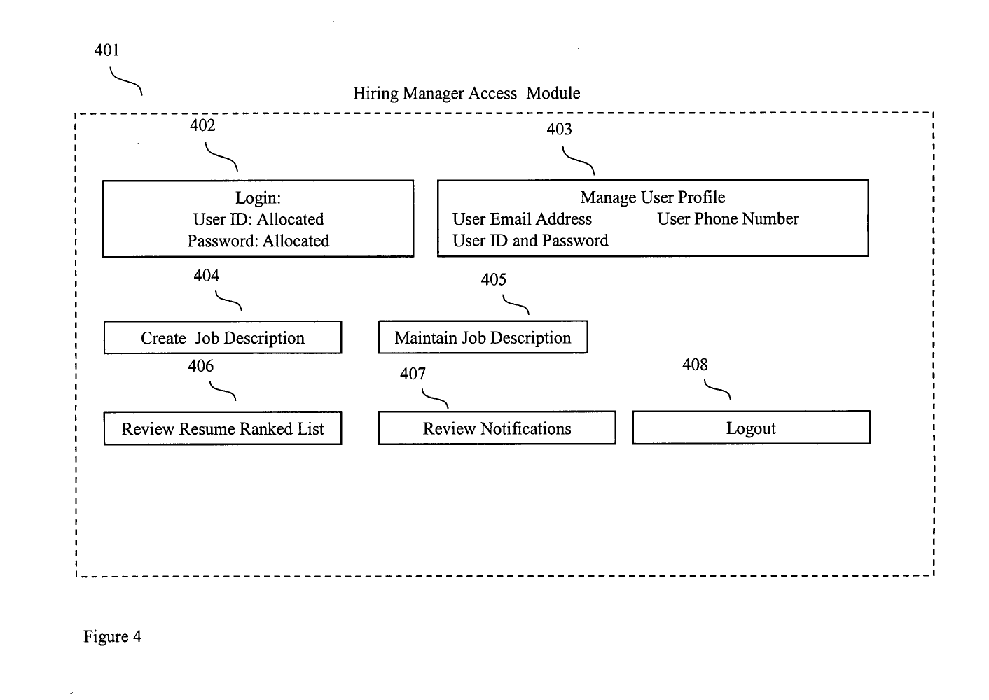

FIG. 4 depicts an exemplary user interface for entering Hiring Manager Access Module 204 further elaborated in 401.

Hiring Manager Access Module 401 can be included as part of matching service provider system to provide login capability 402, manager user profile 403, create job description 404, maintain job description 405, Review Resume Ranked List 406, Review Notifications 407 and Logout 408.

In one aspect, the resume matching services provider 203 can include a web browser (not shown) that can be utilized by hiring manager to enter hiring manager access module 204 and perform login in 402 by using matching services provider allocated User ID and Password in 402 to allow access to capabilities provided by the matching services provider 203 for the hiring manager depicted in 401.

An exemplary capability of hiring manager to manage the user profile in 403. The capability may be enabled after login and include the ability to assign user email address to receive notifications via Notifications Engine, updating user phone number to receive phone calls and short message service messages, updating user id and password.

An exemplary capability of hiring manager to create job description 404, maintain job description 405, review resume ranked list 406, Review Notifications 407 and Logout 408.

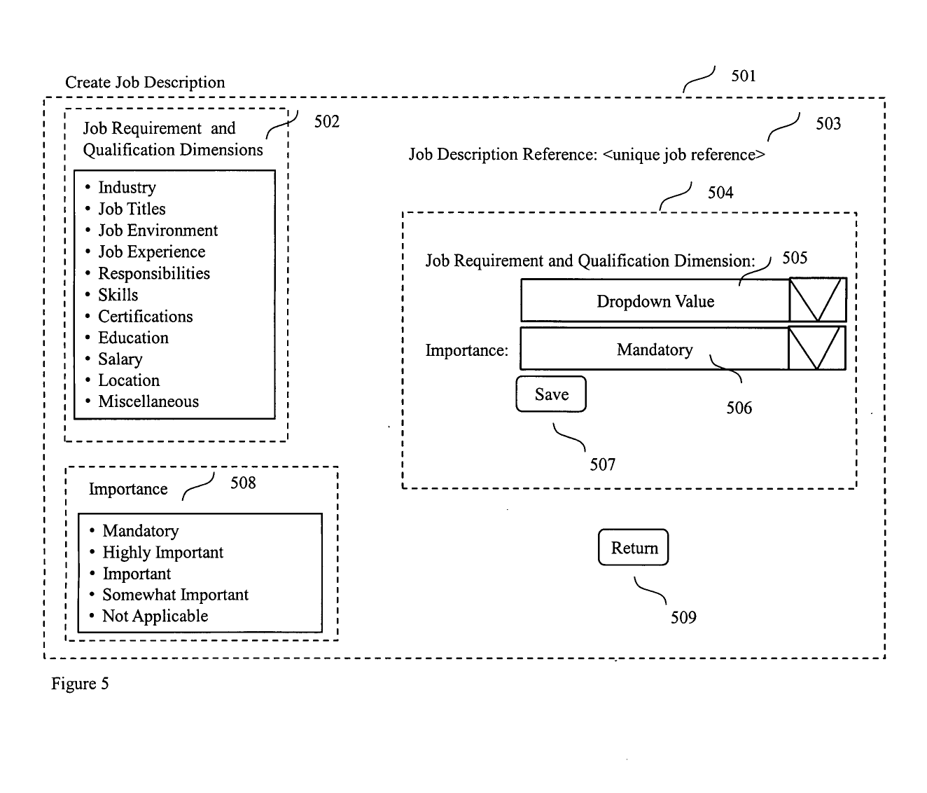

FIG. 5 depicts an exemplary user interface 501 for hiring manager to create job description according to one embodiment. Each new job description is referenced by a unique job description reference 503 by the hiring manager when creating the job description. This reference is used through the processing of the job description within the matching service provider system according to one embodiment. A job description is made up of one or more collection of job requirements and qualification dimensions 502 which are assigned by the Matching Services Provider and chosen from a dropdown list provided via 505 and importance 508 chosen from a dropdown list provided via 506. Each job requirement and qualification dimension with importance is saved using the save button 507 before adding another job requirement and qualification dimension to the job description. When finished assembling the job description a Return button 509 returns the user to Hiring Manager Access Module 401.

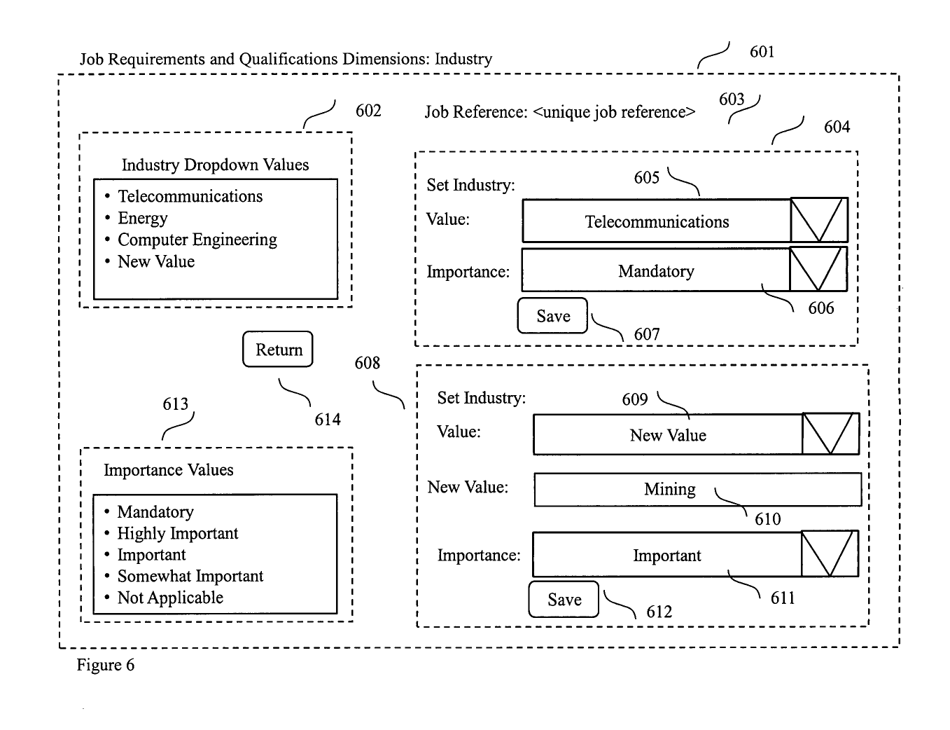

FIG. 6 depicts an exemplary user interface 601 further elaborating creation of job requirement and qualification dimension in 502 further drilling down to values available for each job requirement and qualifications dimension. For example choosing Industry in 505 provides industry dropdown values itemized in 602 for selection via dropdown values in 605. After selecting importance value 613 from drop down 606 the user can save the values with save button 607 and create another job requirement and qualification dimension or click return button 614 to add another job requirement and qualification dimension in 504.

However, if the industry required is not presented in the dropdown values 602, the user can choose the New Value in 605. Resulting in opening a menu 608 to assign New Value Mining by typing Mining in this example in 610, select importance in 611 and save the Job Requirement and Qualification Dimension for Industry with new value Mining. The New Value Mining for Industry will then be available as part of the industry dropdown values. This exemplary user interface can be made available for all other job requirements and qualifications dimensions enabling self learning for dropdown values of job requirements and qualifications dimensions 502 according to one embodiment.

When finished assembling the job description Return button 509 returns the user back to the main menu 401. To end the hiring manager login session the user can select Logout 408.

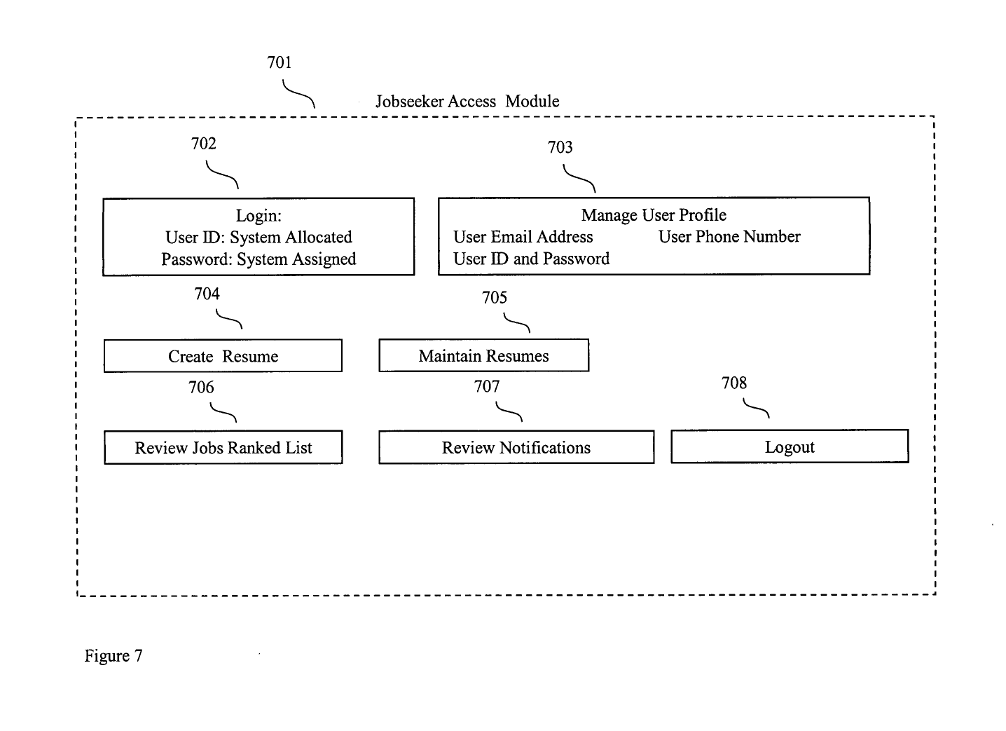

FIG. 7 depicts an exemplary user interface for entering jobseeker Access Module 205 which is elaborated in 701.

The exemplary Jobseeker Access Module 701 can be included as part of matching service provider system to provide login capability 702, managing job seeker user profile 703, create resume 704, maintain resumes 705, Review Job Ranked List 706, Review Notifications 707 and Logout 708.

In one aspect, the job matching services provider 203 can include a web browser (not shown) that can be utilized by jobseeker to enter jobseeker access module 205 and perform login by using matching service provider allocated User ID and Password in 702 to gain access to capabilities provided by the matching services provider 203 for the jobseeker are depicted in 701.

An exemplary capability of jobseeker to manage the user profile is shown in 703. The capability may be enabled after login and include the ability to assign user email address to receive notifications via Notifications Engine, updating user phone number to receive phone calls and short message service messages, and updating user id and password.

An exemplary jobseeker access module capability of jobseeker to create resume 704, maintain resume 705, review job ranked list 706, Review Notifications 707 and Logout 708 are shown in 701.

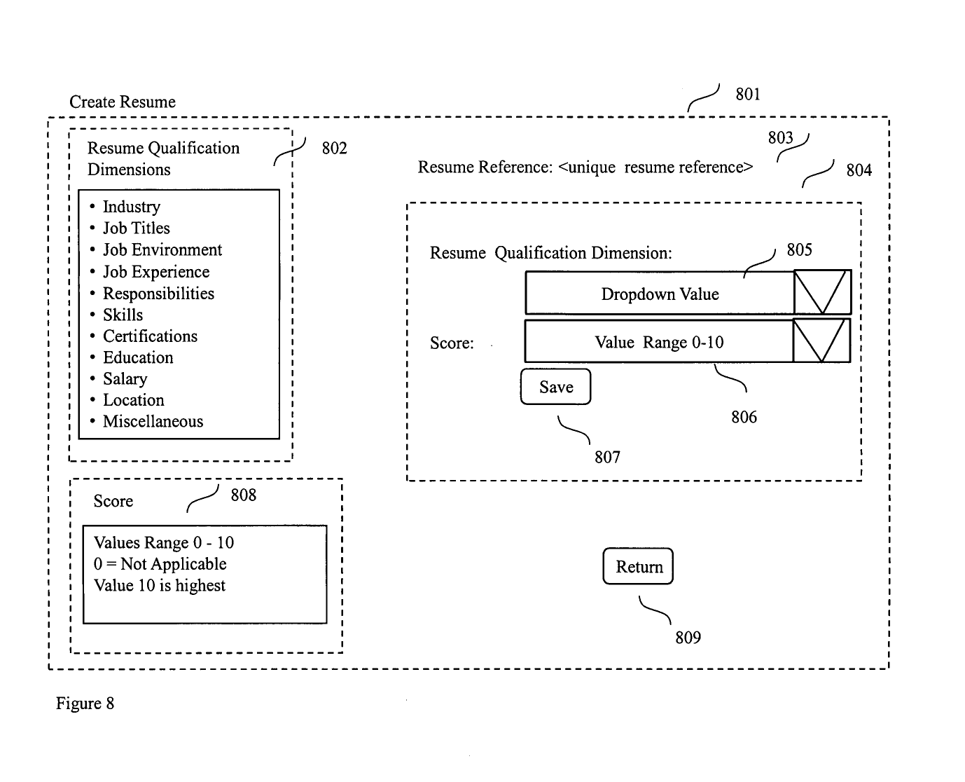

FIG. 8 depicts an exemplary user interface 801 for jobseeker to create resume according to one embodiment. Each new resume is referenced by a unique resume reference 803 by the jobseeker when creating the resume. This reference is used through the processing of the resume within the matching service provider system according to one embodiment. A resume is made up of one or more collection of resume qualification dimensions 802 which are assigned by the Matching Services Provider and chosen from a dropdown list provided via 805 and score 808 chosen from a dropdown list provided via 806. Each resume qualification dimension with score is saved using the save button 807 before adding another resume qualification dimension to the resume. When finished assembling the resume return button 809 returns the user to the jobseeker Access Module 701.

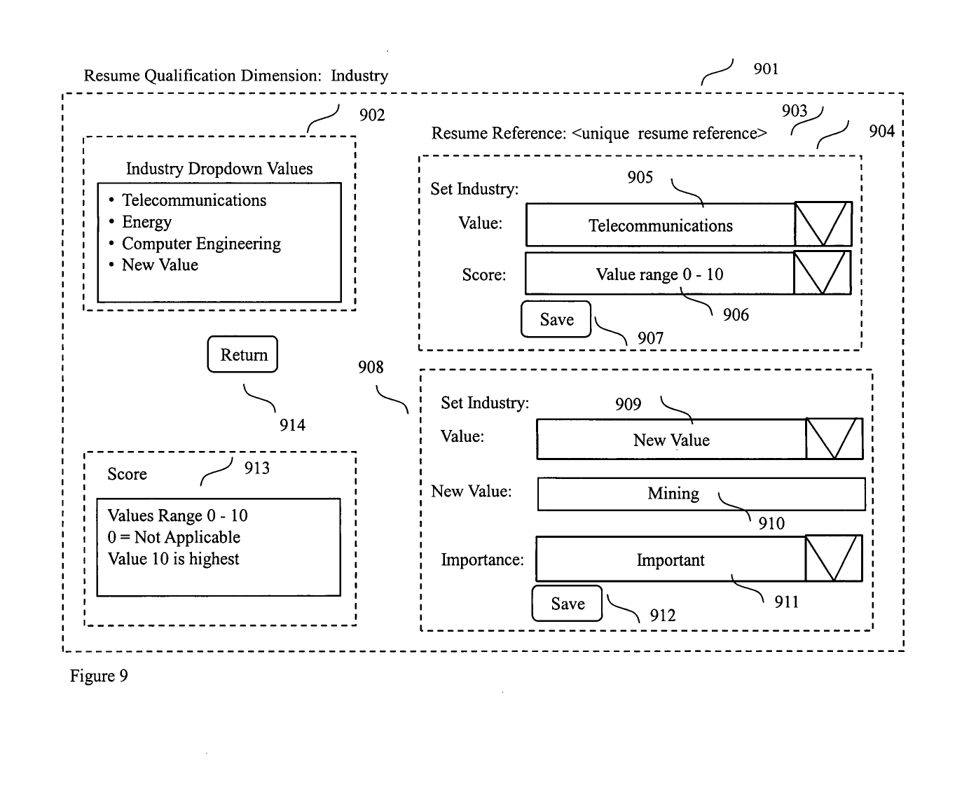

FIG. 9 depicts an exemplary user interface 901 further elaborating creation resume qualification dimension in 902 further drilling down to values available for resume qualifications dimension. For example choosing Industry in 905 provides industry dropdown values itemized in 902 for selection via dropdown values in 905. After selecting score value 913 from drop down 906 the jobseeker can save the values with save button 907 and create another resume qualification dimension or click return 914 to add another resume qualification dimension in 802.

However, if the industry required is not presented in the dropdown values 902, the user can choose the New Value in 905. Resulting in opening a menu 908 to assign New Value by typing the value Mining in this example in 910, select score in 911 and save the resume Qualification Dimension for Industry with new value Mining. The New Value Mining for Industry will then be available as part of the industry dropdown values. This exemplary user interface can be made available for all other resume qualifications dimensions enabling self learning for dropdown values of resume qualifications dimensions 902 according to one embodiment.

When finished assembling the resume Return 809 will return the user back to the main menu 701. To end the jobseeker login session the user can select Logout 708.

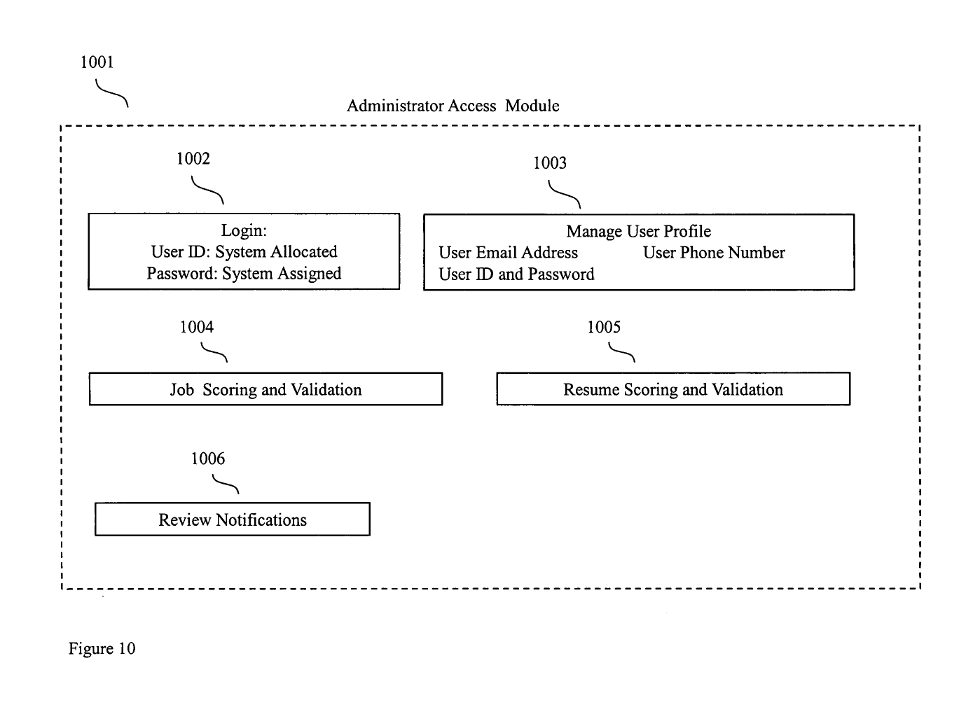

FIG. 10 depicts an exemplary user interface for entering administrator Access Module 206 which is further elaborated in 1001.

The administrator access module 1001 can be included as part of the matching service provider system to provide administrator login capability 1002, manager user profile 1003, job scoring and validation 1004, resume scoring and validation 1005, Review Notifications 1006 and Logout 708.

In one aspect, the job matching services provider 203 can include a web browser (not shown) that can be utilized by administrator access module 206 and perform login in 1002 by using matching service provider allocated User ID and Password in 1002 to allow access to capabilities provided by the matching services provider 203 for the administrator that are depicted in 1001.

After login the administrator can manage own user profile in 1003, perform job scoring and validation 1004, perform resume scoring and validation in 1005, and review notifications 1206.

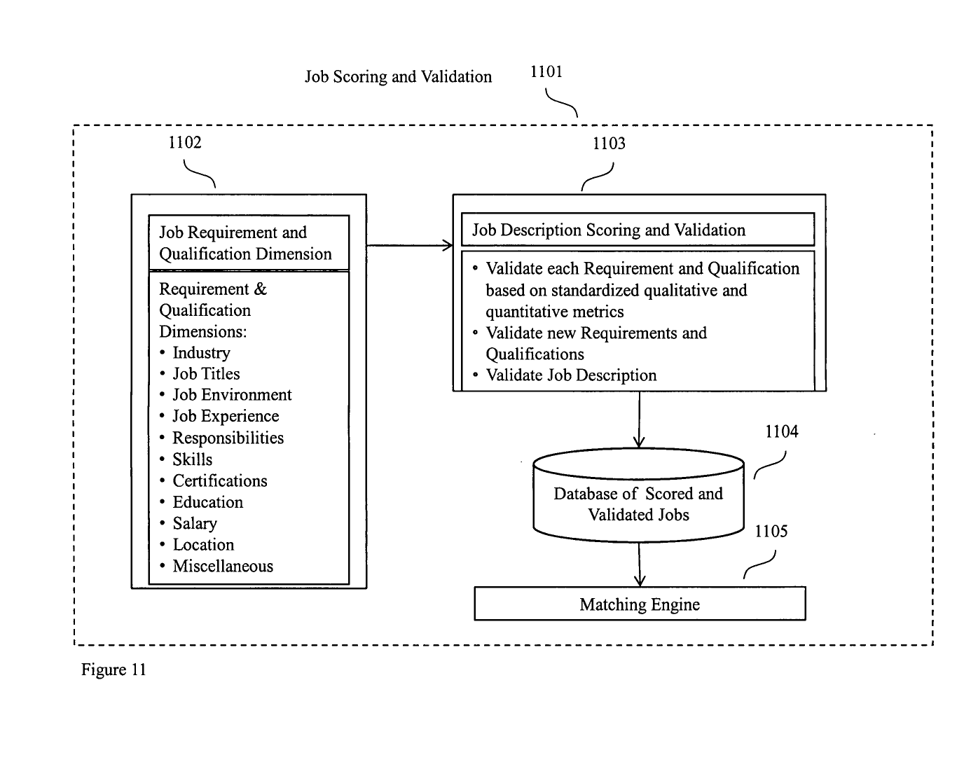

FIG. 11 depicts the process flow of job scoring and validation depicted in 1004. One or more administrators have access to assigned hiring managers' jobs for validation purposes. In a matching services provider model these capabilities are assigned to administrators by the services provider. When a hiring manager finishes creating a new job description in 404 or updates a job description in maintain job description 405, the validation engine 210 validates the job description for data accuracies and notifies the administrator via the notification engine 214 to validate the job description for processing by the matching engine 212.

Furthermore the FIG. 11 depicts the process flow of job scoring and validation. Each job description's job requirement and qualification dimension is reviewed by one or more authorized administrators for accuracy, job dimensions in requirements and qualifications dimensions and finally scored for standardized qualitative and quantitative metadata set provided. This metadata is assigned for all the job requirement and qualifications dimensions. In the matching services provider 203 model it is assigned by the services provider. Any new requirements added during creation of the job description via 608 are also verified. As deemed necessary by the administrator, the job description is updated and marked valid after administrator adjustments to the job requirements and qualification dimension to meet the standardized quantitative and qualitative metrics set by the matching services provider 203. The scored and validated job description is then stored in the database of scored and validated jobs and submitted to the matching engine for further process according to the process flow describe in 101 and according to one embodiment.

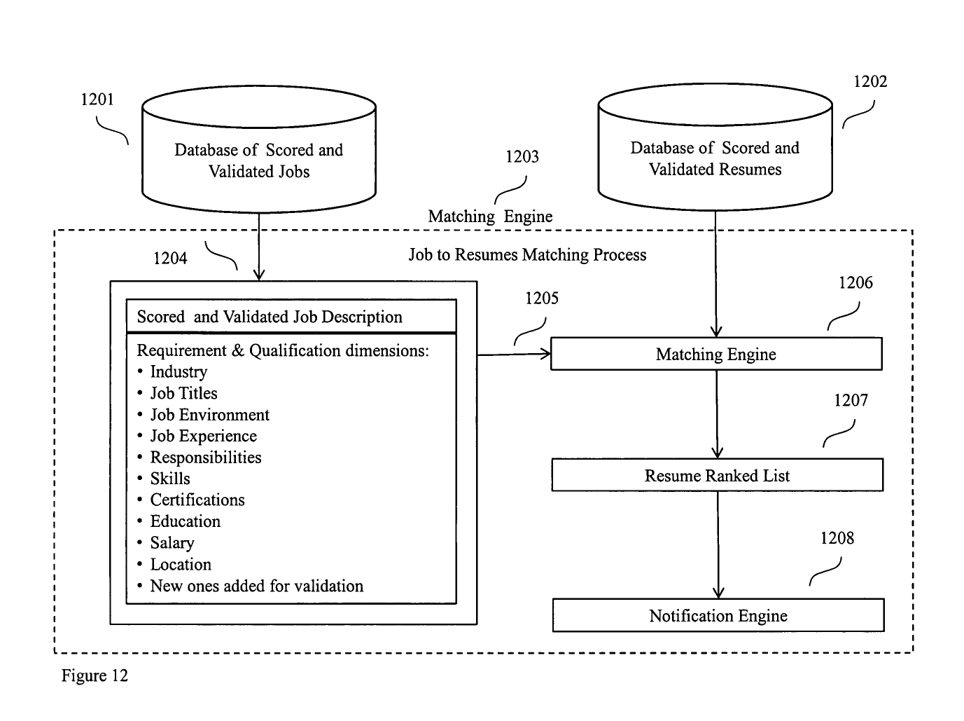

FIG. 12 depicts the process flow for processing scored and validated job descriptions stored in the database of scored and validated jobs according to one embodiment. The entries in this database are marked for processing by the matching engine 1203. The matching engine fetches each marked job for processing and matches, compares and ranks each resume qualification building a ranked list for each requirements and qualification dimension. One job is processed at a time and marked completed. Any errors are reported to the system administrator. The resulting resumes ranked list is submitted for processing by the notification engine. The notification engine send an email or short message service message as defined in the hiring manager's profile. When successfully completed the resumes ranked list is marked processed. Errors are reported to the system administrator.

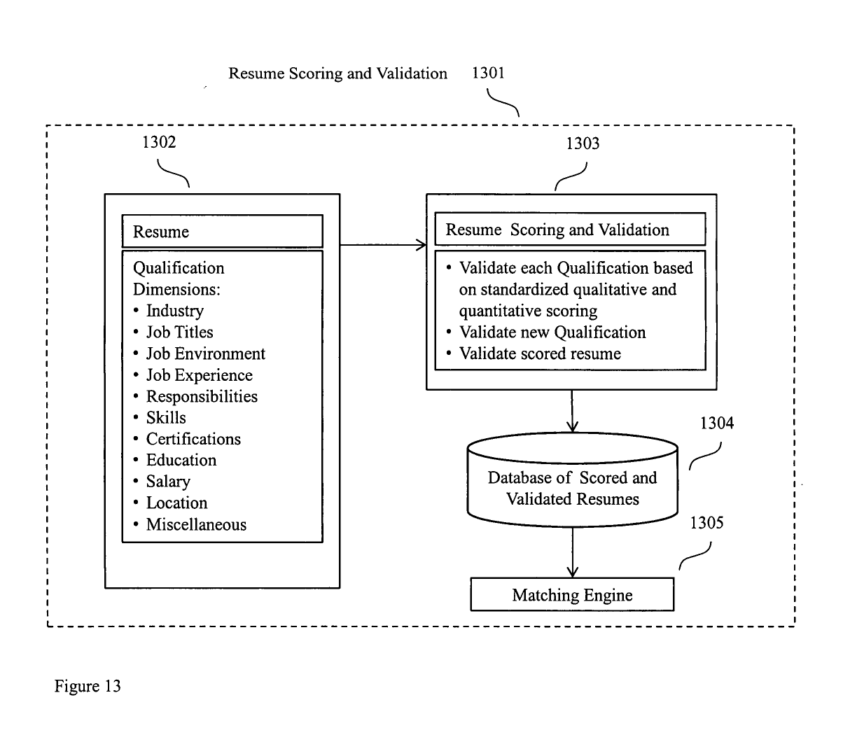

FIG. 13 depicts the process flow of resume scoring and validation depicted in 1005. One or more administrators have access to assigned jobseekers' resumes for validation purposes. In a matching services provider model these capabilities are assigned to administrators by the services provider. When a job seeker finishes creating a resume 704 or updates a resume in maintain resume 705, the validation engine 210 validates the resume for data accuracies and notifies the administrator via the notification engine 214 to validate the resume for processing by the matching engine 212.

Furthermore, the FIG. 13 depicts the process flow of job scoring and validation. Each resume qualification dimension is reviewed by one or more authorized administrators for accuracy, resume dimension qualification and finally scored for standardized qualitative and quantitative metadata set provided. The metadata is assigned for all the qualification dimensions. In the matching service provider 203 model it is assigned by the services provider. Any new requirements added during creation of the resume via 908 are also verified. As deemed necessary by the administrator, the resume description is updated and marked valid after administrator adjustments to the resume qualification dimension to meet the standardized quantitative and qualitative metrics set by the matching services provider 203. The scored and validated resume is then stored in the database of scored and validated resumes and submitted to the matching engine for further process according to the process flow describe in 101.

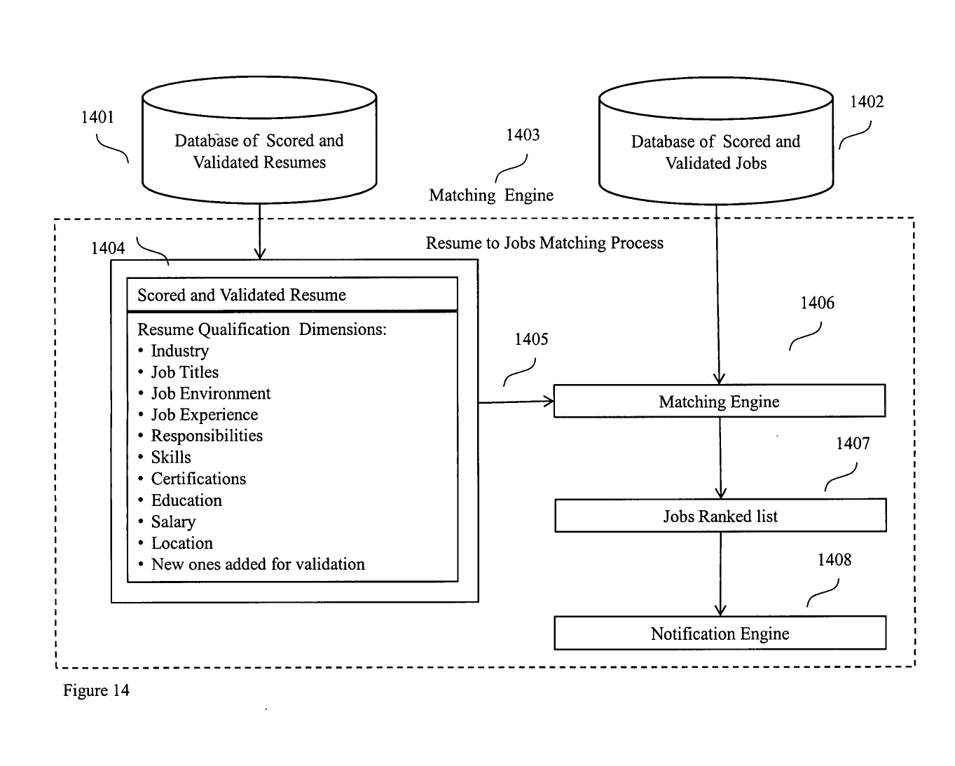

FIG. 14 depicts the process flow for processing scored and validated resumes stored in the database of scored and validated resumes according to one embodiment. The entries in this database are marked for processing by the matching engine 1403. The matching engine fetches each marked job for processing and matches, compares and ranks each job requirement and qualification dimension building a ranked list for each resume qualification dimension. One resume is processed at a time and marked completed. Any errors are reported to the system administrator. The resulting jobs ranked list is submitted for processing by the notification. The notification engine send an email or short message service message as defined in the job seeker's profile. When successful, the jobs ranked list is marked processed. Errors are reported to the system administrator.

What is claimed is:

1. A method for matching jobs and resumes said method comprising:
creating a set of job requirements and qualification dimensions for at least one job;
scoring said set of job requirements and qualification dimensions;
creating a set of resume qualification dimensions for at least one resume;
scoring said set of resume qualification dimensions;
matching said set of scored job qualification dimensions and said set of scored resume qualification dimensions;
automatically create jobs and resumes ranked list of matches.

2. The method of claim 1, wherein said job qualification dimensions include a set of needs for a specific job.

3. The method of claim 1, wherein said resume qualification dimensions include a set of capabilities.

4. The method of claim 1, wherein said scoring includes a weighted number related to the importance of a dimension.

5. The method of claim 1, wherein said scoring is validated by an administrator.

6. The method of claim 1, wherein said ranked list is a list of resumes matched to at least one of said jobs.

7. The method of claim 1, wherein said ranked list is a list of jobs matched to at least one of said resumes.

8. The method of claim 1, wherein a ranked list of matches is communicated to a hiring manager.

9. The method of claim 1, wherein a ranked list of matches is communicated to a jobseeker.

10. The method of claim 1, wherein said resume and said set of scored resume qualification dimensions are stored in a repository as a scored resume.

11. The method of claim 1, wherein said job and said set of scored job qualification dimensions are stored in a repository as a scored job.

12. The method of claim 1, wherein qualification dimensions are modified to accommodate evolving work environments.

13. A system comprising:
a data collection module executing on a computer device, to receive job descriptions and associated job requirements and qualification dimensions and dimensions importance from a hiring manager, resume and associated resume qualification dimensions and dimension scores, administrator validation data for job descriptions and resumes;
a validation and matching engine that receives the job descriptions, resume and administrator validation for scored job descriptions and scored resumes, and creates a ranked list of resumes for each job submitted, and a ranked list of jobs for each resume submitted;
a notification engine that receives the ranked list of resume for each job and the ranked list of jobs for each resume to notify the hiring manager and the job seeker.

14. The system of claim 13 has at least one hiring manager, jobseeker and administrator.

15. The system of claim 13, a hiring manager is an authorized user with a unique profile associated with the hiring manager for posting said job description or descriptions.

16. The system of claim 13, wherein job description and associated job requirements and qualification dimensions and dimensions importance are stored in the hiring manager's profile associated database.

17. The system of claim 13, a jobseeker is an authorized user with a unique profile associated with the jobseeker for posting resume.

18. The system of claim 13, wherein resume description and associated resume qualification dimensions and dimension scores are stored in the job seeker profile associated database.

19. The system of claim 13, an administrator is an authorized user with a unique profile associated with the administrator.

20. The system of claim 13, an administrator is authorized to validate one or more hiring manager's associated job descriptions.

21. The system of claim 13, an administrator is authorized to validate one or more jobseeker's associated resume.
